(19) United States
(12) Patent Application Publication
(10) Pub. No.: US 2002/0120804 A1
(43) Pub. Date: Aug. 29, 2002

(54) Control unit with PCI and SCSI buses and computing system with electronic semiconductor disc

(76) Inventor: Jaroslav Belonoznik, Praha (CZ)

Correspondence Address: George A. Hovanec, Jr., BURNS, DOANE, SWECKER & MATHIS, L.L.P., P.O. Box 1404, Alexandria, VA, 22313-1404, US

(21) Appl. No.: 10/081,194

(22) Filed: Feb. 25, 2002

(30) Foreign Application Priority Data
Feb. 26, 2001 (CZ) PV 2001-720

(51) Int. Cl. G06F 13/14

(52) U.S. Cl. 710/305

(57) ABSTRACT

Use of a control unit with PCI bus and SCSI bus with program equipment for the electronic semiconductor disc of a computing system. The electronic semiconductor disc includes a processor and semiconductor memory, selected from a group comprising dynamic memory, synchronous dynamic memory, static memory and flash type memory. A computing system (1) with electronic semiconductor disc with processor (3), where this processor (3) is connected by a PCI bus (8) to a PCI adapter (4), which is linked through the PCI bus (8) to the semiconductor memory (5), connected by the local bus (9) to a processor (3). The PCI adapter (4) comprises a unit (11) of the programmable SCSI control unit, connected both to the interface (13) of the PCI bus for communicating with the electronic semiconductor disc, and to the interface (12) of the SCSI bus for communicating with the external computing system (2) with the SCSI control unit (6).

### FIELD OF THE INVENTION

The invention involves the arrangement of a PCI adapter in a computing system with an electronic semiconductor disc.

### DESCRIPTION OF THE PRIOR ART

Existing systems with electronic semiconductor SSD discs generally use, as disc capacity, memories of the flash EPROM type, which have very slow access during recording (this defect is overcome by means of a buffer memory, which always has a limited capacity, however) and moreover the number of entries on them are limited (in the order of one hundred thousand to a million in one memory location). The performance and reliability of the whole computing system, operating usually with a database stored in the memory of the electronic semiconductor SSD disc, are thus reduced.

### SUMMARY OF THE INVENTION

The shortcomings of the present state of the art are to a significant extent removed by the solution according to this invention. The basis of the invention lies in the use of the control unit with PCI bus and SCSI bus with program equipment for the electronic semiconductor disc of a computing system. The electronic semiconductor disc includes a processor and semiconductor memory, selected from a group comprising dynamic memory, synchronous dynamic memory, static memory and flash type memory. The processor of the computing system with electronic semiconductor disc is connected by a PCI bus to a PCI adapter, which is linked through the PCI bus to the semiconductor memory, connected by the local bus to a processor, where the PCI adapter comprises a unit of the programmable SCSI control unit, connected both to the interface of the PCI bus for communicating with the electronic semiconductor disc, and to the interface of the SCSI bus for communicating with the external computing system with the SCSI control unit.

The advantage of the solution according to this invention and the difference from currently known solutions of electronic semiconductor discs lies in the use of the industrial standard PCI bus, which makes possible the use of an adapter in various computing systems. From the external viewpoint the adapter has a connection through the industrial PCI and SCSI standards, and from this is derived its universality in applied use. A particularly advantageous use is in heavy load database transactions or in applications which require access to the disc in real constant time, for example in controlling technological procedures or in making audio-visual recordings. The semiconductor memory of the computing system with electronic semiconductor disc can optionally consist of a synchronous dynamic SDRAM memory. Read and write is basically faster than in the EPROM flash type memory and also the number of recordings in the memory is not limited.

The computing system with electronic semiconductor disc optionally also contains a magnetic disc and/or a unit for standby power supply. This alternative serves to permit protection of the data even after disconnection of the electronic semiconductor disc, when its content is automatically recorded on the internal magnetic disc.

The PCI adapter can optionally further contain a memory unit which is connected to the unit of the programmable SCSI control unit in the PCI adapter and/or to the interface of the PCI bus for communicating with the electronic semiconductor disc. The memory unit of the PCI adapter can consist of a programmable EPROM, PEROM, EEPROM or flash EPROM memory. The memory unit of the PCI adapter has a built-in program for controlling the unit of the programmable SCSI bus in the PCI adapter.

The computing system with electronic semiconductor disc is connected by the SCSI bus to the external computing system, from which it receives requests, for example, for reading from or recording onto the disc, which are assessed by the program equipment of the SCSI control unit in the PCI adapter in the disc and through the PCI bus the required data are entered into or read from the synchronous dynamic SDRAM memory.

### BRIEF DESCRIPTION OF THE DRAWINGS

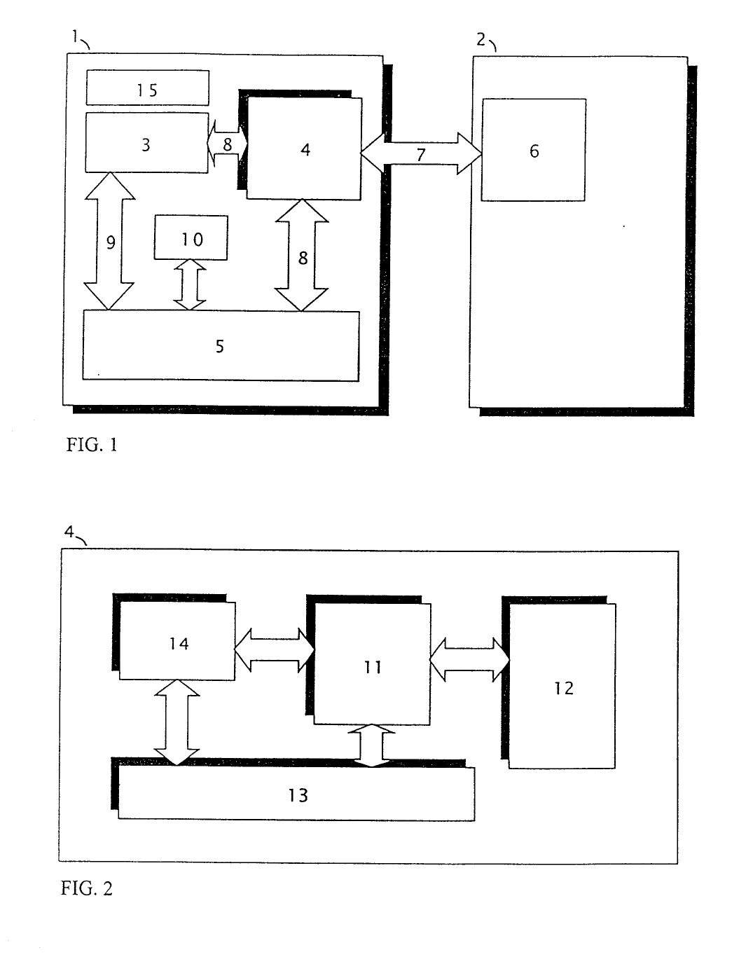

The attached FIGS. 1 and 2 show an example of an embodiment of the computing system with electronic semiconductor disc according to this invention. FIG. 1 is a block diagram of the computing system with electronic semiconductor disc, which is connected to the external computing system. FIG. 2 shows the internal structure of the PCI adapter, which is a part of the computing system with electronic semiconductor disc.

### EXAMPLES OF PREFERRED EMBODIMENTS

The computing system 1 with electronic semiconductor disc is connected by an SCSI bus 7 to an external computing system 2.

The computing system 1 with electronic semiconductor disc consists for example of a personal computer with sophisticated processor and fast SDRAM memory and with a PCI bus. The embodiment of the computing system 1 in FIG. 1 comprises a processor 3, which is connected by a PCI bus 8 to a PCI adapter 4, which is linked through the PCI bus 8 to the semiconductor memory 5 connected by the local bus 9 to a processor 3. The semiconductor memory 5 consists of a synchronous dynamic SDRAM memory and in an alternative embodiment can be connected to a conventional magnetic disc 10. The computing system 1 can also comprise a unit 15 for standby power supply.

The PCI adapter 4 has the following structure. It comprises a unit 11 of the programmable SCSI control unit, connected both to the interface 13 of the PCI bus for communicating with the electronic semiconductor disc, and to the interface 12 of the SCSI bus for communicating with the external computing system 2 with the SCSI control unit 6. The PCI adapter 4 further contains a memory unit 14 which is connected to the unit 11 of the programmable SCSI control unit in the PCI adapter 4 and/or to the interface 13 of the PCI bus for communicating with the electronic semiconductor disc. The memory unit 14 of the PCI adapter 4 consists of a programmable EPROM, PEROM, EEPROM or flash EPROM memory.

From the external computing system 2 with the SCSI control unit 6 requests, for example for reading from or recording onto a disc, go to the computing system 1 with electronic semiconductor disc of the SCSI bus 7, and are assessed by the program equipment in the electronic semiconductor disc and, through the PCI bus 8, the required data are entered into or read from the semiconductor memory 5. The processor 3 in the electronic semiconductor disc at the same time controls the PCI adapter 4 and evaluates the requests from the external computing system 2. The program, which is implemented by the processor 3, is stored in the memory unit 14 (EPROM) of the PCI adapter 4. In an alternative embodiment this program, or part thereof, can be stored in the semiconductor memory of the electronic semiconductor disc.

For the external computing system 2, the computing system 1 with electronic semiconductor disc appears to be a typical disc unit, which has a constant data transfer speed for recording and readout. However, it displays special properties, particularly with regard to a significant reduction in the time taken to access the disc. The improvement over the current situation is very marked, from the present tens of milliseconds to units of a microsecond. The electronic semiconductor disc contains only electronic parts, compared to a conventional disc, which has mechanically moving parts. The reliability and life span of the disc is thereby increased. A disadvantage is however the fact that, before disconnecting the electronic disc, it is necessary to (automatically) record the content onto an internal conventional magnetic disc 10, or it is necessary to equip the whole electronic disc with a standby power supply unit 15.

As was mentioned above, use of the electronic semiconductor disc according to this invention is advantageous in heavy load database transactions or in applications which require access to the disc in real constant time (control of technological processes, making audio visual recordings etc.) The advantage and at the same time the difference of this invention from the other known solutions with electronic semiconductor discs is the use of the industrial standard PCI bus, which makes possible the use of the described adapter in various computer systems. From the external viewpoint the adapter has a connection through the industrial PCI and SCSI standards, and from this is derived its universality in applied use.

Industrial Use

The solution with the electronic semiconductor disc according to this invention can be used particularly in heavy load database transactions or in applications which require access to a disc in real constant time, that is in the control of technological processes, making audio visual recordings etc.

1. Use of a control unit with PCI bus and SCSI bus with program equipment for the electronic semiconductor disc of a computing system.

2. Use of a control unit according to claim 1, where the electronic semiconductor disc includes a processor and semiconductor memory, selected from a group comprising dynamic memory, synchronous dynamic memory, static memory and flash type memory.

3. A computing system with electronic semiconductor disc with processor (3), characterised in that the processor (3) of the computing system (1) is connected by a PCI bus (8) to a PCI adapter (4), which is linked through the PCI bus (8) to the semiconductor memory (5), connected by the local bus (9) to a processor (3), where the PCI adapter (4) comprises a unit (11) of the programmable SCSI control unit, connected both to the interface (13) of the PCI bus for communicating with the electronic semiconductor disc, and to the interface (12) of the SCSI bus for communicating with the external computing system (2) with the SCSI control unit (6).

4. A computing system with electronic semiconductor disc according to claim 3, characterised in that the semiconductor memory (5) consists of a synchronous dynamic SDRAM memory.

5. A computing system with electronic semiconductor disc according to claims 3 or 4, characterised in that it further comprises a magnetic disc (10) and/or a unit (15) for standby power supply.

6. A computing system with electronic semiconductor disc according to any of claims 3 to 5, characterised in that the PCI adapter (4) further contains a memory unit (14) which is connected to the unit (11) of the programmable SCSI control unit in the PCI adapter (4) and/or to the interface (13) of the PCI bus for communicating with the electronic semiconductor disc.

7. A computing system with electronic semiconductor disc according to claim 6, characterised in that the memory unit (14) of the PCI adapter (4) consists of a programmable EPROM, PEROM, EEPROM or flash EPROM memory.

8. A computing system with electronic semiconductor disc according to any of claims 3 to 7, characterised in that it is connected by the SCSI bus (7) to the external computing system (2).
